(19) United States
(12) Patent Application Publication
(10) Pub. No.: US 2006/0207449 A1
(43) Pub. Date: Sep. 21, 2006

(54) Method of creating design on wearing apparel

(76) Inventors: George H. Lotspike, Thousand Oaks, CA (US); Jan Rutkin, Pacific Palisades, CA (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 11/376,814

(22) Filed: Mar. 16, 2006

Related U.S. Application Data
(60) Provisional application No. 60/662,631, filed on Mar. 17, 2005.

(51) Int. Cl. B41M 1/12

(52) U.S. Cl. 101/129

(57) ABSTRACT

A method of creating a design on a piece of clothing comprising creating negative space as a design, by protecting a specific area of the piece of clothing, while distressing the entire rest of the garment. The resulting look is a worn vintage garment with a monochromatic design in the form, color and substance of the original garment prior to distressing.

This application claims the benefit of U.S. Provisional Application Ser. No. 60/662,631 filed Mar. 17, 2005, which application is incorporated herein by reference, in its entirety.

### FIELD OF THE INVENTION

This invention relates to the embellishment of clothing or wearing apparel and related accessories.

### BACKGROUND OF THE INVENTION

Distressing of apparel garments to achieve a vintage look is achieved by the use of a caustic chemical agent applied to the garment in a number of ways, such as being sprayed directly onto the garment, or through the use of an outside source coming in direct contact with the garment.

The desired effect is a random worn look, while maintaining a normal condition throughout the rest of the garment. Each garment is a unique result and it is difficult to achieve a consistent, specific design.

### SUMMARY OF THE INVENTION

Applicants' invention comprises creating negative space as a design, by protecting a specific area, while distressing the entire rest of the garment. The resulting look is a worn vintage garment with a monochromatic design in the form (color and substance) of the original garment prior to distressing.

### DETAILED DESCRIPTION OF THE INVENTION

The method of the invention comprises the following steps:
1. Wool fabric is bonded to a flexible magnetic sheeting material. Wool of about ⅛ inch thick is preferred because it does not melt when the bonded material is laser cut. However, any natural fiber material that is absorbent may be used.
The flexible magnetic material preferably is about 30 mm thick. The wool fabric is bonded to the flexible magnetic sheeting material with an industrial strength adhesive.
The wool fabric is available, for example, from Deccofelt Corporation of Glendora, Calif. The flexible magnetic sheeting is available, for example, from Magnum Magnetics of Marietta, Ohio.
2. A stencil of a specific graphic is laser cut out of the bonded material, (the fabric bonded to the flexible magnetic sheeting). This may be done by the use of a computer generated Adobe Illustrator file of the graphics in an EPS (Encapsulated PostScript) format, such as Version 8. This file is entered into a laser cutting machine to cut the bonded fabric/magnetic sheeting to the desired shape.
3. A 100% cotton garment is dyed. Any color and standard garment dye material may be used. Any garment may be used including, but not limited to, T-shirts, shirts, tops, pants, dresses, etc.
4. The garment is stretched over a solid form, which is in the shape of the garment. Though a sheet metal form is preferred (about ⅜ inch thick) a wood or other non-metallic material may be used, in which case a piece of sheet metal must be attached to the form, in order that the magnetic sheeting side of the stencil will attach itself to the form.
5. The stencil is placed in a desired location and adheres to the garment by means of magnetic attraction, protecting it from outside elements. A template may be used in the shape of the solid form, with the area of the graphics cut out. The template is placed over the garment, after the garment has been stretched over the form, for proper placement of the graphics on the garment.
6. The entire garment is airbrushed with a chemical spray which distresses the garment. A common chemical utilized is Potassium Chlorate in a water solution of from 5% to 15%. It may take from 1 to 6 passes of spray to achieve the desired distressed look, depending upon the fabric weight, color and look desired.
7. The stencil is then removed revealing the graphic, because the area of the garment covered by the stencil, held onto the garment by magnetic attraction, has been protected and has not been exposed to the chemical spray. The garment is held between the metal form and the magnetic sheeting on the back of the stencil.
8. The garment is then placed in a neutralizing solution, such as Sodium Metabisulfite for from about 3 minutes to about 5 minutes, and then washed and dried.

An alternative method in Step 1, is to manufacture the stencil by bonding wool to sheet metal and making the form from a magnetic material. The garment is still being held magnetically between a metal and a magnetic material, only reversing the location.

By the use of the methods described herein, a clear graphic image is realized on the garment, in the original color of the garment, while the balance of the garment has been given a distressed look. This graphic image may be exactly repeated on multiple garments by the use of the stencil and the methods described herein.

Having thus described the invention, we claim:

1: A method of creating a design on a garment comprising creating negative space as a design, by protecting a specific area of the garment, and distressing the entire rest of the garment.

2: A method of creating a design on a garment comprising bonding a natural fiber material to a flexible magnetic sheeting material, cutting a stencil out of the bonded material, dying the garment, placing the garment over a metal form which is in the shape of the garment, placing the stencil in a desired location on the garment, spraying the entire garment with a chemical spray which distresses the garment, placing the garment in a neutralizing solution, then washing and drying the garment.

3: The method of claim 2 in which the natural fiber material is wool.

4: The method of claim 3 in which the wool is about ⅛ inch thick.

5: The method of claim 2 in which the flexible magnetic material is about 30 mm thick.

6: The method of claim 2 in which the stencil is cut by a computer operated laser cutting machine

7: The method of claim 2 in which the garment is 100% cotton.

8: The method of claim 2 in which the metal form is solid metal or sheet metal attached to a non-metal form.

9: The method of claim 2 in which the garment is stretched over the metal form.

10: The method of claim 2 in which the stencil comprises a template with the area of the graphics cut out.

11: The method of claim 2 in which chemical spray is Potassium Chlorate in a water solution of about 5% to about 15%.

12: The method of claim 2 in which the neutralizing solution is Sodium Metabisulfite.

13: The method of claim 2 in which the garment is placed in the neutralizing solution for about 3 minutes to about 5 minutes.

14: A method of creating a design on a garment comprising bonding a natural fiber material to a flexible metal sheeting material, cutting a stencil out of the bonded material, dying the garment, placing the garment over a magnetic metal form which is in the shape of the garment, placing the stencil in a desired location on the garment, spraying the entire garment with a chemical spray which distresses the garment, placing the garment in a neutralizing solution, then washing and drying the garment.

15: The method of claim 14 in which the natural fiber material is wool.

16: The method of claim 15 in which the wool is about ⅛ inch thick.

17: The method of claim 14 in which the stencil is cut by a computer operated laser cutting machine

18: The method of claim 14 in which the garment is 100% cotton.

19: The method of claim 14 in which chemical spray is Potassium Chlorate in a water solution of from about 5% to about 15%.

20: The method of claim 14 in which the neutralizing solution is Sodium Metabisulfite.
